(19) United States
(12) Patent Application Publication
(10) Pub. No.: US 2003/0194287 A1
(43) Pub. Date: Oct. 16, 2003

(54) Clamp load indicator device for fasteners

(76) Inventor: David C. Hageman, Chagrin Falls, OH (US)

Correspondence Address: The Universal Group of Companies, 24400 Northline Road, Taylor, MI, 48180, US

(21) Appl. No.: 10/122,717

(22) Filed: Apr. 15, 2002

(51) Int. Cl. F16B 31/02

(52) U.S. Cl. 411/9

(57) ABSTRACT

A clamp load indicating device (10) for fasteners is made from two flat washers (12) and a tubular crush element (18) mounted between the flat washers. A ring gauge member (14) is interposed between the washers and about the tubular crush element. The camp indicator device is mounted about the shaft (34) of a fastener and when sufficient clamp load is exerted thereon, the crush element crushes to allow the flat washers to engage with the ring gauge member and rotatably affix it with the washers.

### TECHNICAL FIELD

The field of this invention relates to a indicating device for use with fasteners to provide an indication of clamp load exerted by the fasteners.

### BACKGROUND OF THE DISCLOSURE

When two materials are assembled together, the fasteners that clamp the two materials together provide a clamp load. This load should not be so great as to extrude, compress or otherwise mar the material parts that are being fastened. Furthermore, the tension load on threaded fasteners such as a bolt and nut should be less than the yield point of the fasteners. The clamp load on the material parts and the tension load on the fasteners are substantially equal and opposite and for the purposes of this application, the term “clamp load” is used in the generic sense to indicate either the loads on the fastened parts or the tension loads on the fastener elements themselves.

Threaded fasteners are often fastened by use of a torque wrench which provides for an indication of torque necessary to further tighten the fastener. While these torque wrenches are popular, they do not provide a direct measurement of the clamp load. The torque can be affected by the friction between the threaded fastener and the fastened part or nut, the quality of the lubricant used, a defect in the threads, or even the cleanliness of the fasteners. This variation in torque is without an equivalent or proportional variation in the clamp load thus throwing the indication accuracy off.

Clamp load indicating devices have been attempted in the past. Most of these devices use expensive test equipment, or require modification of the fastener itself. Others use encapsulated liquids, or use extruding plastic or rubber materials to sense the clamp loads. Other clamp load indicators use beveled or conical washers with expensive swage connections. The conical washers have a spring like or toggle like effect which provides for variable loads that deflect the conical washers for its load indicating function.

What is needed is a clamp load indicating device for a threaded fastener assembly that uses inexpensive flat washers and a reliable crush element that crushes under a constant load.

What is also needed is a clamp load indicating device that can engage a lever of predetermined length that can provide a torque to determine if sufficient clamp loads are exerted on the indicator device.

### SUMMARY OF THE DISCLOSURE

In accordance with one aspect of the invention, a clamp load indicating device for fasteners includes two coaxial washers members being normally spaced apart with a common axis passing through central apertures of said washer members. A co-axially mounted tubular crush element connects the two coaxial washer members together. A ring gauge member is normally rotatably mounted between the two coaxial washer members and about the tubular crush element. The ring gauge member engages both of the coaxial washer members and becoming rotatably affixed with said washers upon a predetermined amount of movement of said coaxial washers toward each other as said tubular crush element is crushed by the predetermined amount.

Preferably, the tubular crush element is crushable under a constant predetermined load. It is also preferred that the ring gauge member is constructed to be engaged with a lever tool of predetermined length that extends substantially transverse from the common axis. In one embodiment, the ring gauge member has a polygon shaped outer surface, which desirably is hexagon, that is engagable to the lever tool which in one embodiment is a wrench with a handle having a predetermined length.

Alternatively, the ring gauge member has a polygon shaped outer surface, which is desirably a hexagon. The ring gauge member desirably engages a torque wrench. The torque wrench has an indicator which reads the torque needed to rotate the ring gauge member. A low torque reading by the torque indicator, indicates that the clamping load is low. The fastener elements can then be re-tightened to their original clamp load as indicated by a higher reading on the torque indicator.

In another embodiment, the ring gauge member has at least one radially extending hole with its axis substantially transverse to the common axis for receiving an end of the lever tool of predetermined length.

In another embodiment, the ring gauge member has a knurled or textured outer surface for frictional engagement with the operator's fingers. It is desired that the washers are flat and have inner opposing flat bearing surfaces are engagable to opposite flat faces of the ring gauge member.

In accordance with another aspect of the invention, a clamp load indicating device for fasteners includes a ring gauge member normally rotatably mounted between two co-axially mounted washer members connected to each other about a common axis that define a space wherein the ring gauge member is normally rotatably seated. The washer members have opposing facing bearing surfaces normally spaced from said ring gauge member. The washers are relatively movable upon a predetermined clamping pressure extruded onto said washers to engage opposite sides of the ring gauge member and to rotatably affix the ring gauge member with the washers. The ring gauge member has an outer surface constructed to be engagable to a lever tool of predetermined length. The lever tool is engagable with the ring gauge member for exerting a torque force about said common axis.

### BRIEF DESCRIPTION OF THE DRAWINGS

Reference now is made to the accompanying drawings in which:

FIG. 1 is side elevational and sectional view of the clamp load indicator in accordance with one embodiment of the invention in use with a fastener assembly clamping a pair of fastened members prior to a load being applied thereto;

FIG. 2 is side elevational and sectional view of the clamp load indicator shown in FIG. 1;

FIG. 3 is a plan view of a clamp load indicator shown in FIG. 2;

FIG. 4 is view similar to FIG. 1 after a sufficient clamp load is applied thereto;

FIG. 5 is a plan view of a second embodiment of the invention;

FIG. 6 is side elevational view and partially sectioned view taken along lines 6-6 as shown in FIG. 5;

FIG. 7 is a view of the second embodiment with the ring gauge member engaged to a wrench of predetermined length;

FIG. 8 is a plan and partially segmented view of a third embodiment of the invention;

FIG. 9 is a side elevational and segmented view of a third embodiment of the invention with the lever of predetermined length attached thereto; and

FIG. 10 is a plan view similar to FIG. 7 showing the engagement to a torque wrench.

### DETAILED DESCRIPTION OF THE PREFERRED EMBODIMENT

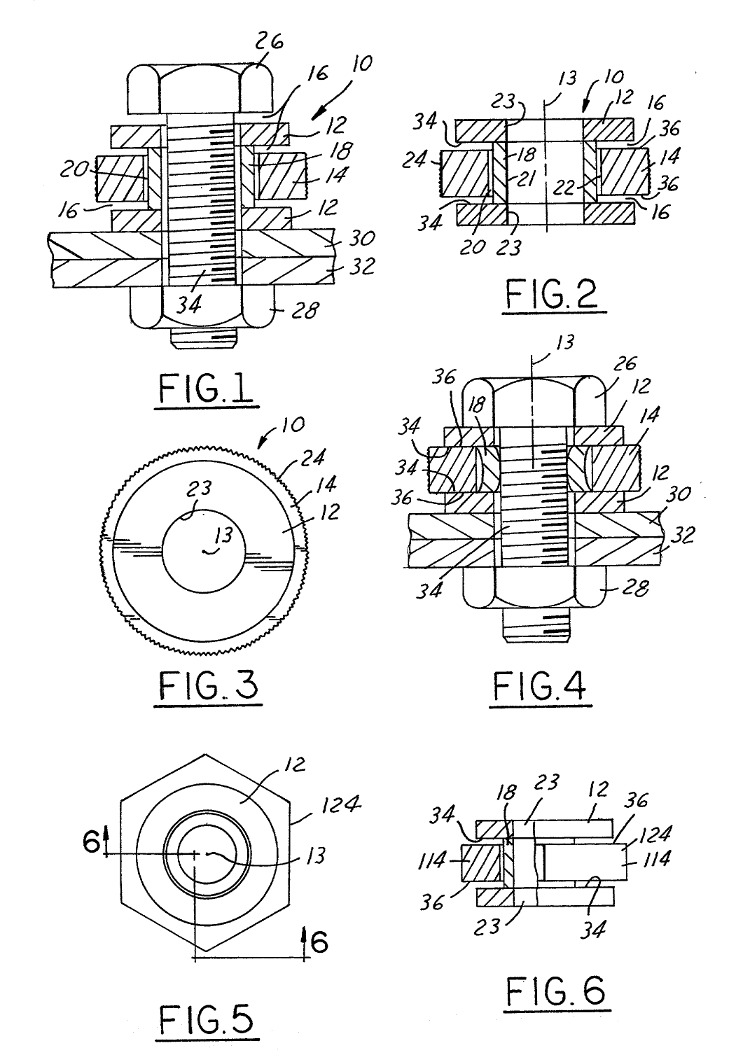

Referring now to FIGS. 1 and 2, a clamp load indicator device 10 includes two flat washers 12 commonly mounted about a common axis 13 and a ring gauge 14 interposed therebetween. In an unloaded condition as shown in FIGS. 1 and 2, the washers provide at least one gap 16 therebetween such that the ring gauge 14 is freely rotatable with respect to the washers 12.

The washers are connected to each other via a tubular crush element 18. The crush element can be made from a perforated metal or a deformable plastic. The tubular crush member is constructed to deform under a constant predetermined load. It is foreseen that many crush elements at different predetermined loads can be manufactured to meet the highly varied demands for fasteners.

It is desired that the crush element is connected to the two flat washers such that they form a unitary assembly that contains the gauge ring therein. A solder, brazing, or adhesive may be sufficient for the purpose of pre-assembly of the washers to the crush element. The crush element has a diameter sized to provide a clearance 20 with the inner diameter or inner wall 22 of the ring gauge member 14.

The crush element has an inner diameter or bore 21, that is aligned with central apertures 23 of the washers centered about common axis 13.

As illustrated in FIG. 3, the outer wall 24 of the ring gauge member can be grooved, knurled or otherwise textured to enhance manual finger engagement by an operator. The washers and ring gauge members generally have circular contours.

In operation, as shown in FIG. 1, the bolt 26, nut 28 and two fastened members 30 and 32 are assembled. While it is known that the clamp load indicating device 10 is under the bolt head, it can alternatively be positioned between the nut 28 and the member 32.

Referring now to FIG. 4, the bolt 26 and nut 28 are tightened and as the clamp load increases to the predetermined amount as set by the crush element 18, the crush element 18 commences to be crushed by the clamping forces transmitted through the washers 12. The washers 12 move toward each other and close the gaps 16 such that the inner flat bearing surface 34 engage lower and upper flat faces 36 of the ring gauge 14. The ring gauge 14 becomes rotatably affixed with respect to the washers 12. An operator can determine whether the ring gauge 14 is affixed by manually placing a finger or thumb on it outer wall 24 and attempt to rotate the ring gauge. If the operator cannot rotate the ring gauge 14, this is an indication that the desired clamp load is achieved.

The bolt 26 has a shank 34 with an outer diameter that allows the crush element 18 to crush radially inward and form a seal with the shank 34. The crush element as shown in FIG. 4 does not contact the ring gauge as it is crushed.

The crush element 18 rebounds slightly when the load on the fastener joint is reduced. The reduction in clamp load will again permit the ring gauge member 14 to rotate with finger pressure. Re-applying the original clamp load will again prevent the ring gauge member from turning.

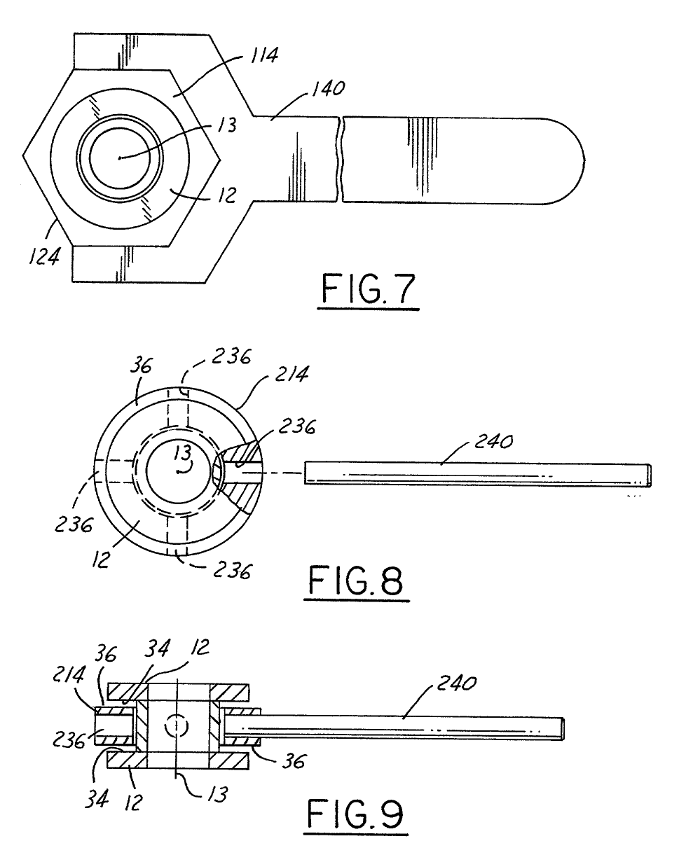

Referring now to FIGS. 5-7, a second embodiment is illustrated. The ring gauge member 114 of the second embodiment has an outer surface 124 that has a polygon shape and more specifically a hexagon shape in order to engage a wrench 140 of a predetermined length as shown in FIG. 7. The operator can engage the wrench to the ring gauge member 114 and with the wrench apply a torque on the ring gauge element. If the clamp load is proper, the ring gauge remains affixed with the washers in spite of the torque applied by the operator via the wrench 140.

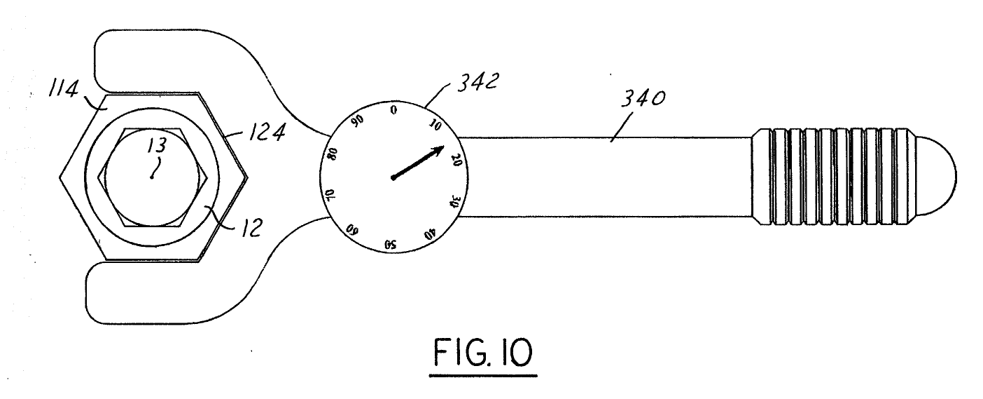

Reference is now made to FIGS. 8 and 9 where a ring gauge member 214 has several radially extending apertures 236 circumferentially spaced thereabout that can be engaged by a lever 240 of predetermined length. After the crush element 18 is crushed and the washers 12 engage the ring gauge member 214, the lever 240 has a distal end 242 sized to be received in the aperture 236. Once engaged, the operator can exert a torque onto the ring gauge member 214 to determine if the ring gauge member is rotatably affixed relative to the washers which indicates that the proper clamp load is being exerted.

FIG. 10 shows the usage of a torque wrench 340 having an indicator dial 342 thereon. The torque wrench engages the clamp load indicator as previously described with reference to FIG. 7. If a torque load is lower than predetermined amount as indicated in dial 342, the bolt 26 and nut 28 can be further tightened until the torque indicator dial 342 reads a sufficiently higher torque that indicates that higher clamping loads are then exerted on the clamp indicator. If the bolt 26 becomes loose, it can be re-tightened to its original clamp load which is verified by the torque dial 342, as the wrench is turned.

In this fashion, a clamp load indicating device can be used with conventional standard fasteners such as a nut and bolt, or a screw without the need for expensive test equipment. The clamp indicator is made from inexpensive elements such as flat washers, a tubular crush element, and a ring gauge member. The indicating device provides for a direct measuring of the clamp load. The indicator device can be inspected to assure that the clamp load is achieved.

Furthermore, the rebounding of the crush element provides that the fastener can be retightened to the specified clamp loads using the same indicating device.

The clamp load can be predetermined by the proper selection of a crush element that crushes under set loads. In this manner, the invention can be used with any suitable fastener strength level.

Other variations and modifications are possible without departing from the scope and spirit of the present invention as defined by the appended claims.

The embodiments in which an exclusive property or privilege is claimed are defined as follows:

1. A clamp load indicating device for fasteners, said device characterized by:
two coaxial washers members being normally spaced apart, with a common axis passing through central apertures of said washer members;
a co-axially mounted tubular crush element connecting the two coaxial washer members together;
a ring gauge member normally rotatably mounted between the two coaxial washer members and about the tubular crush element;
said ring gauge member engaging both of said coaxial washer members and becoming rotatably fixed with said washers upon a predetermined amount of movement of said coaxial washers toward each other as said tubular crush element is crushed by said predetermined amount.

2. A clamp load indicating device as defined in claim 1 further characterized by:
said tubular crush element being crushable under a constant predetermined load.

3. A clamp load indicating device as defined in claim 2 further characterized by:
said ring gauge member constructed to be engaged with a lever tool of predetermined length that extends substantially transverse from the common axis.

4. A clamp load indicating device as defined in claim 3 further characterized by:
said ring gauge member having a polygon shaped outer surface that is engagable to said lever tool which is a wrench with a handle having a predetermined length.

5. A clamp load indicating device as defined in claim 3 further characterized by:
said ring gauge member having at least one radially extending hole with its axis substantially transverse to the common axis for receiving an end of said lever tool of predetermined length.

6. A clamp load indicating device as defined in claim 2 further characterized by:
said ring gauge member having a knurled outer surface for frictional engagement with the operator's fingers.

7. A clamp load indicating device as defined in claim 2 further characterized by:
said ring gauge member having a polygon shaped outer surface that is engagable to a lever tool which is a torque wrench with a torque indicator mounted thereon.

8. A clamp load indicating device as defined in claim 1 further characterized by:
said ring gauge member constructed to be engaged with a lever tool of predetermined length that extends substantially transverse from the common axis.

9. A clamp load indicating device as defined in claim 8 further characterized by:
said ring gauge member having a polygon shaped outer surface that is engagable to said lever tool which is a wrench with a handle having a predetermined length.

10. A clamp load indicating device as defined in claim 8 further characterized by:
said ring gauge member having at least one radially extending hole with its axis substantially transverse to the common axis for receiving an end of said lever tool of predetermined length.

11. A clamp load indicating device as defined in claim 1 further characterized by:
said washers being flat and having inner flat face bearing surfaces engagable to substantially flat opposite faces of said ring gauge member.

12. A clamp load indicating device as defined in claim 1 further characterized by:
said ring gauge member having a polygon shaped outer surface that is engagable to a lever tool which is a torque wrench with a torque indicator mounted thereon.

13. A clamp load indicating washer device characterized by:
a ring gauge member normally rotatably mounted between two co-axially mounted washer members connected to each other about a common axis that define a space wherein said ring gauge member is normally rotatably seated;
said washer members having opposing face bearing surfaces with at least one normally spaced from said ring gauge member; and movable upon a predetermined clamping pressure exerted onto said washers to engage opposite faces of said ring gauge member;
said ring gauge member having an outer surface constructed to be engagable to a lever tool of predetermined length;
said lever tool engagable with said ring gauge member for exerting a torque force about said common axis.

14. A clamp load indicating device as defined in claim 13 further characterized by:
said ring gauge member having a polygon shaped outer surface that is engagable to said lever tool which is a wrench with a handle having a predetermined length.

15. A clamp load indicating device as defined in claim 14 further characterized by:
said ring gauge member having at least one radially extending hole with its axis substantially transverse to the common axis for receiving an end of said lever tool of predetermined length.

16. A clamp load indicating device as defined in claim 13 further characterized by:
said opposing face bearing surface of said washers being substantially flat and said opposite faces of said ring gauge member being substantially flat.

17. A clamp load indicating device as defined in claim 13 further characterized by:
said ring gauge member having a polygon shaped outer surface that is engagable to a lever tool which is a torque wrench with a torque indicator mounted thereon.
